(19) United States
(12) Patent Application Publication
(10) Pub. No.: US 2009/0067178 A1
(43) Pub. Date: Mar. 12, 2009

(54) Method of forming light-scattering dots inside the diffusion plate and light guide plate by laser engraving

(75) Inventors: Hsin-Tao Huang, Zhubei City (TW); Chun-Chung Hsiao, Caotun Township (TW)

Correspondence Address: BACON & THOMAS, PLLC, 625 SLATERS LANE, FOURTH FLOOR, ALEXANDRIA, VA, 22314-1176, US

(73) Assignee: KISMART CORPORATION, Taipei City (TW)

(21) Appl. No.: 12/068,143

(22) Filed: Feb. 4, 2008

Related U.S. Application Data
(60) Provisional application No. 60/971,559, filed on Sep. 11, 2007.

(51) Int. Cl. F21V 5/00; B23K 26/00

(52) U.S. Cl. 362/326; 219/121.85

(57) ABSTRACT

The present invention discloses a method of forming internal scattering pattern in the diffusion plate and light guide plate used in backlight module by laser engraving. In the present invention, the distribution and density of the engraved dots can be controlled and modulated depending on the position of the light source and the distribution of luminance to obtain higher luminance and better luminance uniformity.

### FIELD OF THE INVENTION

The present invention generally relates to a light diffusion plate, more particularly relates to a diffusion plate and light guide plate (LGP) with laser engraving pattern formed therein to improve the uniformity of luminance and brightness thereof.

### DESCRIPTION OF THE PRIOR ART

Up to this day, TFT-LCD (thin film transistor liquid crystal displayer) has replaced CRT (cathode-ray tube) displayer on a mass scale no matter in the field of computer, consumer or communication electronics. Substantially, TFT-LCD has the characteristics of thinner thickness, lighter weight, accompanied with the advantage of lower radiation compared to the conventional CRT displayer, thus TFT-LCD panel can be well-accommodated to the current popular electronic products such as notebook, PDA, cellphone, digital camera, flat panel TV, projector and digital photo frame that full of commercial potential in current 3C industry. Stimulated by the low price of LCD panel and the demand for electronic products with light weight, portability and thin package, TFT-LCD has become the primary display technology around the world in recent year.

LCD panel is primarily composed of color filter, backlight module, driver IC, compensation film, polarizer, glass panel, ITO layer and control circuit, etc. In the fabrication of LCD panel, the manufacturers have to combine the color filter with glass panel first and fill in the liquid crystal. The other components, such as backlight module, driver IC, control circuit, is then assembled with said liquid crystal panel to make LCD module and be sold to the downstream manufacturer, for example, the manufacturer of notebook or LCD displayer for further fabrication. Since the liquid crystal panel can't emit light by itself, a backlight module is necessary for LCD panel to provide the light source. Therefore, the prosperity of TFT-LCD industry is also promoting the demand for backlight and the components in connection with.

Backlight module is one of the key components in LCD panel. Its importance is only next to the color filter in LCD panel. The backlight module is primarily composed of light source, lamp cover, reflector, light guide plate, diffuser, brightness enhancement film (BEF) and the housing, wherein the fabrication of optical film and light guide plate are their most important technique and cost in chief. With the tendency of light weight, thin package, low power consumption for LCD panel, to develop novel backlight module and study new injection molding for the component is the endeavoring direction and important scheme of LCD industry currently.

The main purpose of backlight module is to provide an uniform, high-brightness light source (is so-called plane light). The basic principle of plane light is to convert the common-used point light or linear light into a plane light having high brightness and luminance uniformity. Generally, the light source of backlight module must be provided with the characteristics of high brightness and long life time. Current-used light source for backlight module includes CCFL (cold cathode fluorescent lamp), LED (light emitting diode) and EL (electro luminescent), wherein the CCFL has the characteristic of high luminance, high emitting efficiency, long life time and high color rendering. Also, the tubular shape of CCFL is adaptive to combine with light reflecting element to form a plate-type illuminating device. Thus, CCFL is current primary light source for LCD panel. Conventionally, CCFL is used in large-sized backlight module, As for small-sized backlight module (such as those used in the PDA, digital camera, cellphone), LED is usually used to provide the light source with low power consumption, thinner volume.

Generally, the structure of backlight module can be divided into two categories depending on their lamp positions: direct-light type and edge-light type, as showed in FIG. 1a and FIG. 2a. In FIG. 1a, a plurality of light source 101 is disposed space-parted under the diffusion plate 103 of direct-light type backlight module 100. The light emitted from light source 101 (ex. CCFL lamp, LED light source) is propagating upwardly through the diffusion plate 103 and be scattered uniformly to form the plane light on LCD panel 105. Because there are sufficient room under the diffusion plate 103 for lamp disposition, the direct-light type backlight module can be provided with two or more lamp tubes (or numerous LED light source disposed in array) depending on the size of LCD panel, but this also increases the weight, thickness and power consumption of the whole LCD module. A reflector 104 is disposed under the light source 101 to reflect the scattering light beams back to the diffusion plate 103 and prevent the emitting light leaking out of the backlight module 100. The advantage of direct-light type backlight module is its high luminance, high luminance efficiency, good viewing angle, and simple structure, thus it can be accommodate to large-sized LCD TV or LCD monitor. Though the diffusion plate 103 is used in direct-type backlight module to improve the luminance uniformity of LCD panel, the luminance performance of this design is still worse. As shown in FIG. 1b, the diffusion plate 110 is provided with numerous diffusion particles 107 spread therein. The diffusion particles (such as PMMA, polymethylmethacrylate) 107 can be used to scatter the incident light emitted from light source 101 in all directions due to the different refractive index between transparent plastic material (PMMS, PC, MS, PS . . . ) 103 and diffusion particle 107. Because it is hard to control the density distribution of diffusion particles 107 in the transparent plastic material 103, the diffusion particle 107 is generally spread uniformly within the transparent plastic material 103, thus its capability to average the luminance on LCD panel is limited and nulled. As shown in FIG. 1b, which is the distribution of luminance along the X-axis in a common direct-light type backlight module. The maximum luminance performed (Lₘₐₓ) is aligning to the position of light source 101 along the X-axis, while the minimum luminance performed (Lₘᵢₙ) is aligning to the midpoint between two light sources 101 along the X-axis. The difference of Lₘᵢₙ and Lₘᵢₙ defines the luminance uniformity on the LCD panel. When the different of Lₘᵢₙ and Lₘᵢₙ exceeds 100 nits, there would be very apparent distribution of dark and bright stripes on the LCD panel, which is so-called lamp mura. Accordingly, some approaches are made to resolve this problem. Referring to FIG. 1c, which illustrates an alternative method to improve the luminance uniformity of the direct-light type backlight module in the prior art. In FIG. 1c, the diffusion plate 110 is additionally provided with numerous dots 109 distributed in specific pattern on the bottom surface or top surface thereof. The dot 109 in current example can be the micro structure formed by ink printing or other method. As shown in FIG. 1c, the incident light is reflected by the dots 109 spread in specific pattern on the diffusion plate 110, thus the luminance propagating through the diffusion plate is nearly identical in different position. More dots are formed on the position aligning to the light source 101 to reflect more incident lights compared to other position along the X-axis. Thus the luminance corresponding to the position of light source 101 is lowered to average the whole luminance performing. Though the method of forming micro structure in specific pattern on the bottom of diffusion plate can obtain better uniformity of luminance than the method in FIG. 1b (i.e. the difference of Lₘᵢₙ and Lₘᵢₙ in FIG. 1c is smaller than that in FIG. 1b), its improvement is still confined due to the distribution of dot pattern can only be two dimensional. Further, the absorption of incident light by diffusion particle 107 and dots 109 indicates that lesser incident light is allowed to pass and propagate through the diffusion plate 110, thus the luminance of backlight module is lowered. Accordingly, there is still a demand to develop new method to improve the luminance uniformity of the diffusion plate.

Referring now to FIG. 2a, which illustrates the structure of an edge-light type backlight module in prior art. The light source 201 of edge-light type backlight module structure 200 is disposed at the lateral side of the backlight module. Since the edge-light design can make LCD panel thinner, lighter and lower power consumption, it is usually used in mid, small-sized LCD panel, such as the displayer of cellphone, PDA, notebook as their light source. One of the most important components in edge-light type backlight module is light guide plate 203, which can significant influence the light efficiency and luminance uniformity. The main purpose of light guide plate 203 is guiding the incident light to increase the luminance and control the luminance uniformity of the LCD panel. As shown in FIG. 2a, the light emitted from the light source 201 can propagated through light guide plate 203 to the other side by total internal reflection (TIR). Light guide plate 203 is generally made of high refractive index material without light absorption. A number of micro structures 205 are formed on the bottom side of light guide plate 203 to violate the mechanism of total internal reflection for the light to propagate out of the light guide plate 203 from the top side. Subsequently, the light will propagate through the lower diffusion film 207, prism sheet 209 and upper diffusion film 211 to LCD panel 213. By controlling the density and size of the micro structure 205 formed on the bottom surface of light guide plate 203, the luminance uniformity of the LCD panel 213 can be improved. In general, the micro structure 205 can be formed by the method of ink printing or direct injection molding. Among them, V-cut is one of the popular and effective micro structures used in the fabrication of light guide plate. As shown in FIG. 2b, v-cut technique is to forming numerous V-shape grooves regularly on the bottom surface of light guide plate. Because the structure is similar to forming the prism sheet directly on the light guide plate, the cost of prism lens layer can be omit, and it can also increase the luminance of LCD plane up to 30%. Though V-cut light guide plate has some advantages, it still suffers the uniformity issue. As shown in FIG. 2b, the regular disposition of V-shaped groove 215 on the light guide plate 203 cause the luminance distribution near the light source 201 is in grating form within the distance A, and the luminance uniformity beyond the distance A is worse too. Accordingly, V-cut structure is likely to produce dark and bright stripes on the LCD panel which is so-called kido mura, as shown in FIG. 2b. Rather than the uniform luminance, the manufacture of V-cut light guide plate needs mold opening process, which requires extra time and cost to develop. Furthermore, the transcription quality for V-cut structure is another issue to consider.

### SUMMARY OF THE INVENTION

The present invention discloses a novel method of forming internal scattering pattern/dot in the diffusion plate and light guide plate by laser engraving to improve the uniformity of luminance of the LCD panel and resolve the kido mura and curtain mura issue in the prior art.

Laser engraving is the process of producing the fine grooves or cracks on the substrate to form the characters or objects. This technique utilizes the material (such as crystal or PMMA) with transparency and high refractive index to form internal pattern or images. Laser engraving is free of the surface residues and does not require post process polishing. Also, the 2-dimentional or 3-dimentional manipulation with laser engraving is relatively easy. Therefore, it is an excellent method to form accurate dot pattern distribution inside the transparent material.

One embodiment in the present invention is provided with a method of forming internal scattering dots within a diffusion plate by laser engraving. The density distribution of the scattering dots engraved therein is in the form of Gauss distribution whose minimum is aligning to the midpoint between the light sources disposed under the diffusion plate, and whose maximum is aligning to the position of light sources. The density distribution of scattering dots in this embodiment can compensate the non-uniform distribution of luminance in corresponding position to improve the luminance uniformity on the LCD panel and resolve the lamp mura issue. Besides, forming scattering dots inside the diffusion plate can also increase the whole luminance of the LCD panel.

In another embodiment in the present invention, a method is provided to forming internal scattering dots within a light guide plate by laser engraving to resolve the kido mura issue in the conventional light guide plate with V-cut microstructure, wherein the internal scattering dots is provided in the area where the kido mura occurs in the light guide plate to scatter the incident light and dark, bright stripes in this area.

In another embodiment in the present invention, a method is provided to forming internal scattering dots within a light guide plate by laser engraving to resolve the curtain mura issue in the conventional light guide plate with LED light source, wherein the internal scattering dots is provided in the area where the curtain mura occurs in the light guide plate to scatter the incident light concentrated on the position aligned to the LED light source to average the entire luminance distribution on light guide plate.

In still another embodiment in the present invention, a method is provided to forming internal scattering dots within a light guide plate by laser engraving, wherein the internal scattering dots can be arranged on a plurality of pattern plane space-aparted and/or parallel from each other. The dot density of said pattern planes and the pitch between said pattern planes can be modulated cooperatively or respectively depending on the original luminance distribution of the light guide plate. The density distribution of scattering dots in this embodiment can compensate the non-uniform distribution of luminance in corresponding position to improve the luminance uniformity on the LCD panel and resolve the mura issue. Besides, forming scattering dots inside the light guide plate can also increase the whole luminance of the LCD panel.

In still another embodiment in the present invention, a method is provided to form internal scattering dots within a light guide plate by laser engraving, wherein the internal scattering dots are arranged on a plurality of sinusoidal curve which propagate along the light guide plate. The dot density and cycle distance of the sinusoidal curves can be modulated cooperatively or respectively depending on the original luminance distribution of said light guide plate. The density distribution of scattering dots in this embodiment can compensate the non-uniform distribution of luminance in corresponding position to improve the luminance uniformity on the LCD panel and resolve the mura issue. Besides, forming scattering dots inside the light guide plate can also increase the whole luminance of the LCD panel.

One object of present invention is to form internal scattering dots inside the diffusion plate and light guide plate by laser engraving.

Another object of present invention is to provide a method for improving the luminance uniformity of diffusion plate and light guide plate by laser engraving.

The laser engraving method provided in present invention can be utilized both in the fabrication of direct-light type and edge-light type backlight modules. The scattering dots can also be engraved on the top surface and bottom surface of the diffusion plate and light guide plate.

The laser engraving method provided in present invention can also coordinate with other diffusion technique such as ink printing, diffusion particles and micro structure, etc, to further improve the luminance uniformity of the LCD panel.

The forgoing forms and other forms, objects, and aspects as well as features and advantages of the present invention will become further apparent from the following detailed description of the presently preferred embodiments, read in conjunction with the accompanying drawings. The detailed description and drawings are merely illustrative of the present invention rather than limiting the scope of the present invention being defined by the appended claims and equivalents thereof.

### BRIEF DESCRIPTION OF THE DRAWINGS

FIG. 1a illustrates the cross section view of conventional direct-light type backlight module structure in prior art;

FIG. 1b illustrates one structure of the diffusion plate and the relating luminance distribution of the direct-light type backlight module in prior art;

FIG. 1c illustrates another structure of the diffusion plate and the relating luminance distribution of the direct-light type backlight module in prior art;

FIG. 2a illustrates the cross section view of conventional edge-light type backlight module structure in prior art;

FIG. 2b illustrates the cross section view of the light guide plate with V-cut micro structure and the relating luminance distribution of the edge-light type backlight module in prior art;

FIG. 2c illustrates the cross section view of the light guide plate with V-cut micro structure and engraved dots and the relating luminance distribution of the edge-light type backlight module in the embodiment of present invention;

FIG. 3a illustrates one structure of the diffusion plate with engraved dots and the relating luminance distribution of the direct-light type backlight module in the embodiment of present invention;

FIG. 3b illustrates the LED light sources which are disposed in array in the embodiment of present invention;

FIG. 4 illustrates one structure of the light guide plate with LED light source and the relating luminance distribution of the edge-light type backlight module in the embodiment of present invention;

FIG. 5a illustrates the structure of the light guide plate with parallel plane distribution and the relating luminance distribution of the edge-light type backlight module in the embodiment of present invention;

FIG. 5b illustrates the structure of the light guide plate with sinusoidal curve distribution and the relating luminance distribution of the edge-light type backlight module in the embodiment of present invention;

### DESCRIPTION OF THE PREFERRED EMBODIMENT

The invention will now be described in greater detail with preferred embodiments of the invention and illustrations attached. Nevertheless, it should be recognized that the preferred embodiments of the invention is only for illustrating. Besides the preferred embodiment mentioned here, present invention can be practiced in a wide range of other embodiments besides those explicitly described, and the scope of the present invention is expressly not limited expect as specified in the accompanying Claims.

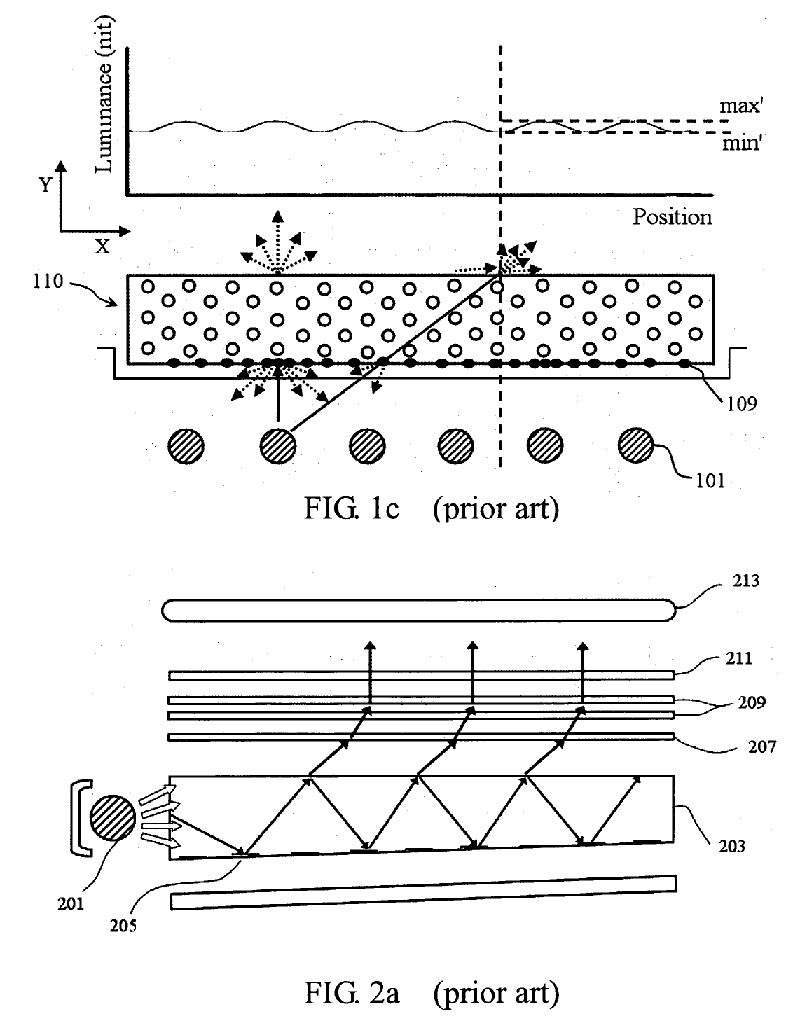

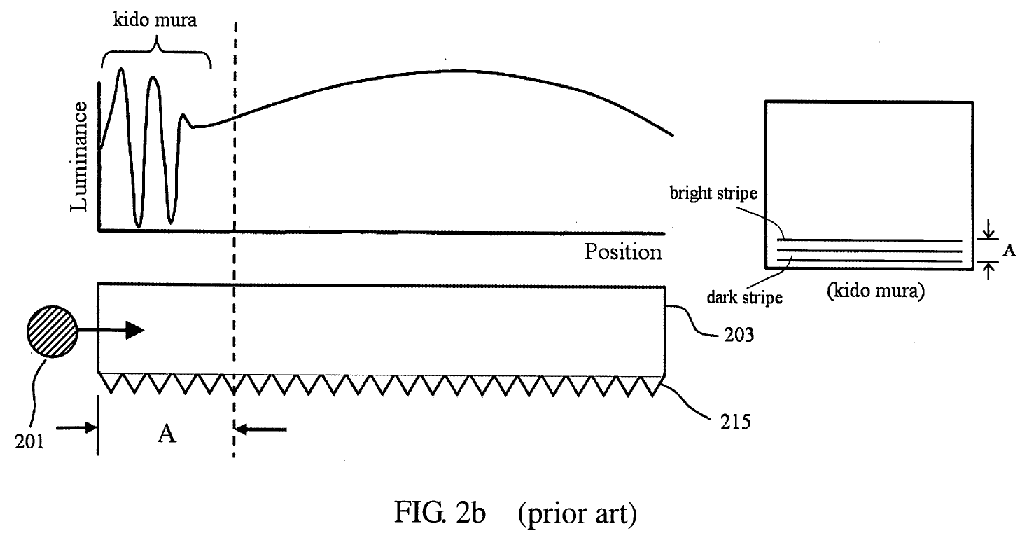

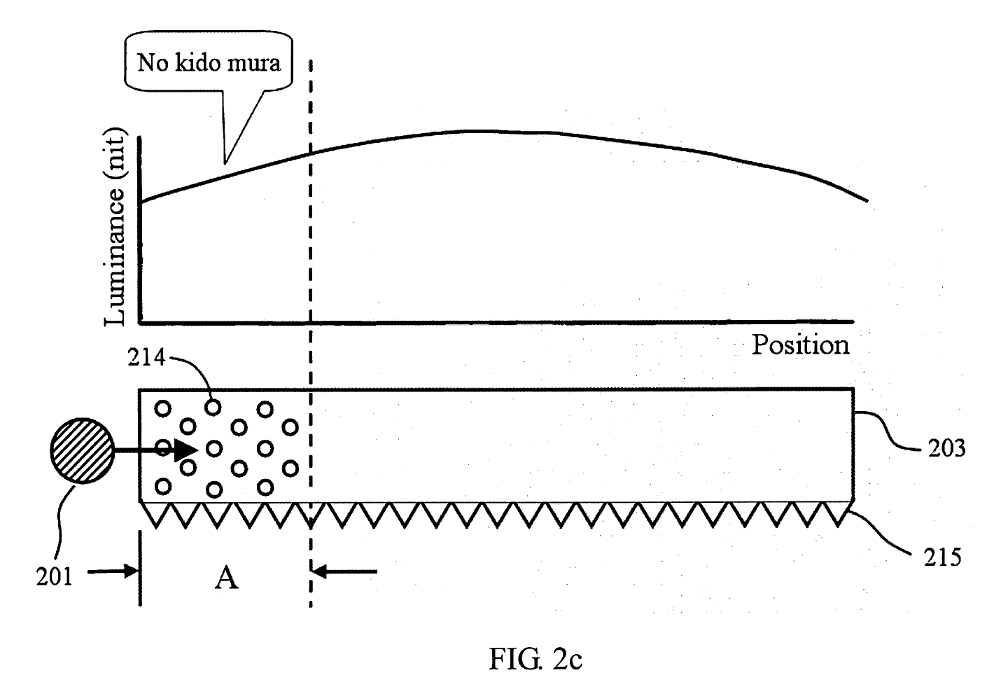

Referring first to FIG. 2c, which illustrates the cross-section view of a light guide plate with V-cut microstructure and laser engraving dots in the embodiment of present invention. In the figure, a light guide plate 203 is provided with V-cut microstructure 215 on the bottom surface thereof. A light source 201 is disposed at the lateral side of light guide plate 203. The distance A in FIG. 2c is identical to the distance A in FIG. 2b, which indicates the area where the kido mura occurs in conventional light guide plate with V-cut microstructure. Numerous dots 214 are engraved at the area A inside the light guide plate 203 to scatter the incident light from light source 201. In the embodiment of present invention, the light scattered by dots 214 can smooth the dark and bright stripes produced by V-cut microstructure in the area A and resolve the kido mura issue. The resulted luminance distribution along the light guide plate 203 in this embodiment is like the curve C shown in the FIG. 2c, where the luminance distribution within the area A has no grating pattern such as those shown in the FIG. 2b.

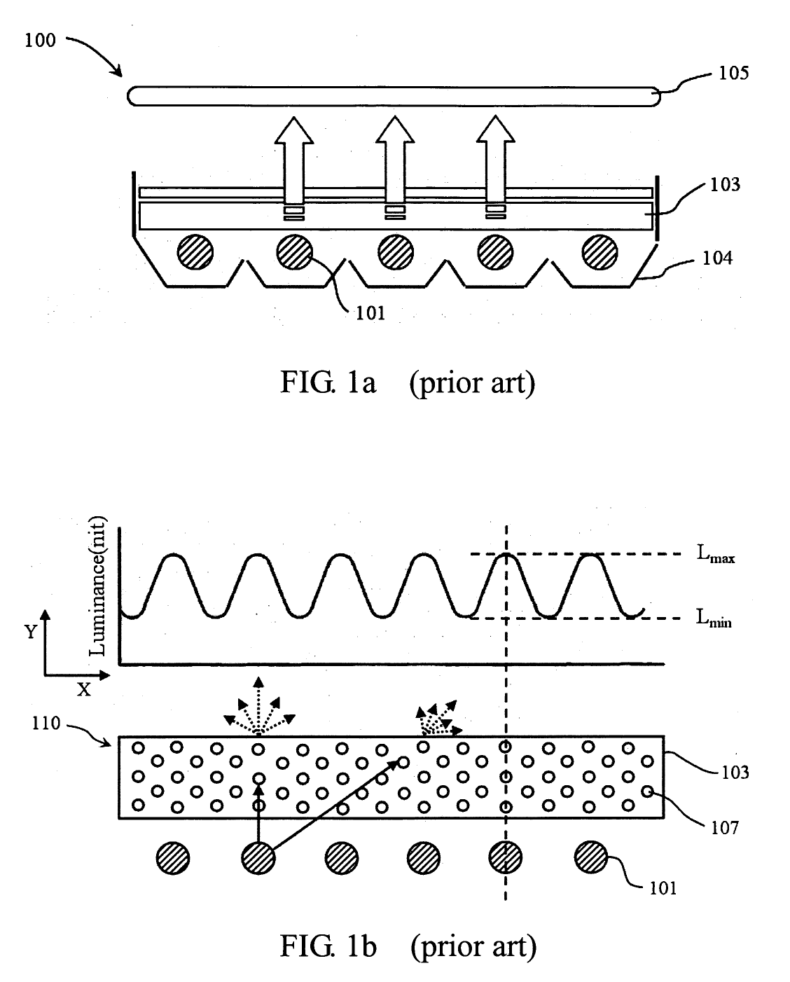

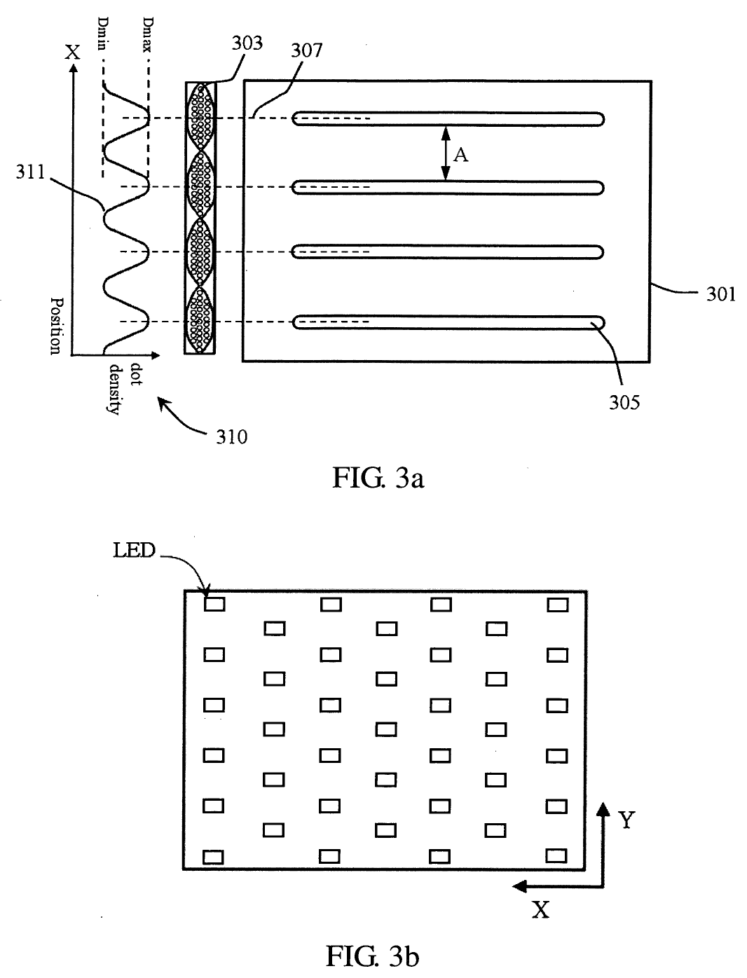

Referring now to FIG. 3a, which illustrates the density distribution of the internal dots (or cracks) engraved in diffusion plate along X-axis and the top view of a diffusion plate in the embodiment of present invention. In the figure, block 301 represents a diffusion plate commonly used in the backlight module. A plurality of light source (ex, CCFL lamp) 305 space-aparted and parallel from each other is disposed under the diffusion plate 301 along the X-axis. In FIG. 3a, the coordinate axis 310 delineates the distribution of dot density 311 in diffusion plate 301 along the X-axis. As shown in the coordinate axis 310, the dot density 311 along the X-axis in diffusion plate 301 is a Gaussian distribution function. The position of maximum (Dₘₐₓ) and minimum (Dₘᵢₙ) of dot density 311 in coordinate axis 310 is depending on the arrangement of light source 305 and the number of dots 303 in diffusion plate 301. Generally, the position of maximum dot density (Dₘₐₓ) along X-axis is aligning to the position of light sources 305 (aligned with vertical dashed line 307) in the embodiment of present invention, while the position of minimum dot density along X-axis is aligning to the midpoint between two light source 305. The reason to form dot pattern in Gaussian distribution and align the maximum and minimum of dot density to specific position is because the luminance on the top side of diffusion plate 301 is not uniform, as shown in FIG. 1b. For example, in direct-light type backlight module structure, because the light source is not true plane light (ex. the CCFL linear light or LED point light), the luminance measured on the top side of diffusion plate 301 is also in Gaussian distribution rather than a gentle linear distribution. As illustrated in FIG. 1b, the position of maximum luminance along X-axis on diffusion plate 103 is aligning to the position of each light sources 101 disposed thereunder along the X-axis, while the position of minimum luminance along X-axis on diffusion plate 103 is aligning to the position of midpoint between two light sources 101, and the value of |Lₘᵢₙ−Lₘᵢₙ| in FIG. 1b is only slightly averaged even by utilizing diffusion particle or bottom pattern printing to scatter the incident light, as shown in FIG. 1b and FIG. 1c respectively. Accordingly, the dot density in the form of Gaussian distribution is used to compensate the luminance deviation in the embodiment of present invention. Since the luminance right above the light source on LCD panel is in its maximum value (i.e. the Lₘₐₓ in FIG. 1b), the number of dot (i.e. the Dₘₐₓ in FIG. 3a) formed by laser engraving inside the diffusion plate 301 in this position must be most comparing to the dot number of other position along X-axis to scatter or suppress more light beam than other position comparably, thus the total luminance distribution will be averaged. Oppositely, the number of dot right above the midpoint between two light sources 305 inside the diffusion plate 301 is in its minimum value (i.e. the Dₘᵢₙ in FIG. 3a) to allow more light beams passing comparing to other position. The coordination of dot density 311 and corresponding luminance along the X-axis can average the entire luminance performance on the diffusion plate 301 to attain better luminance uniformity. Note that the distance A between each CCFL lamp disposed under the diffusion plate 301 in the embodiment is not necessarily identical, and CCFL lamps need not to be parallel from each other too. The dots distribution inside the diffusion plate 301 depends substantially on the position of light sources thereof.

Note that the embodiment in FIG. 3a is merely for the purpose of the description. The disposition of CCFL lamps in present embodiment is only one kind of light source arrangement in present invention. For direct-light type backlight module, referring to FIG. 3b, which illustrates a top view of light source arrangement on a plane. Numerous LED light sources can be arranged in array on a plane, every LED served as individual point light source for diffusion plate. The interaction between all LED lamps disposed in X direction and Y direction should be considered in the calculation of dot density distribution in diffusion plate. In general conclusion, no matter which kind of light sources is applied, or what kind of arrangement the light source is disposed, the density of dot pattern is distributed around the light source center in Gaussian distribution in the direct-light type backlight module structure.

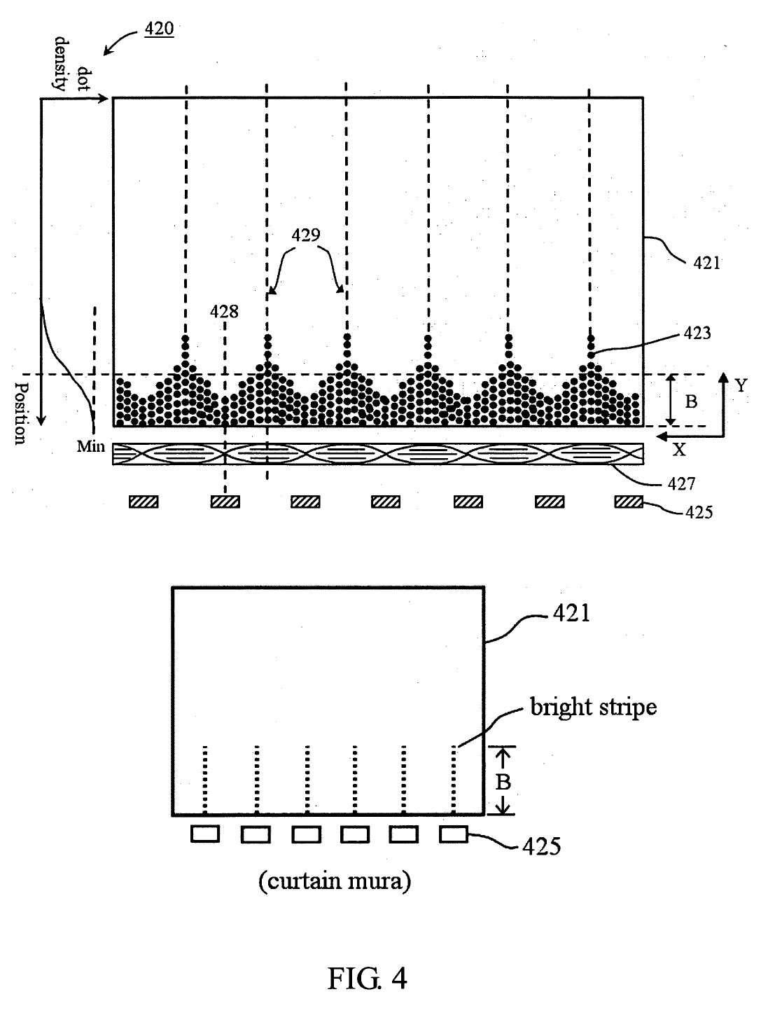

Referring now to FIG. 4, which illustrates the top view of a light guide plate and the dots density distribution along X-axis and Y-axis therein respectively in the embodiment of present invention. In the figure, block 421 represents a light guide plate (top view) commonly used in the edge-light type backlight module. A plurality of light source (ex, LED light source) 425 space-aparted from each other is disposed at the lateral side of the light guide plate 421 along the X-axis. As shown in FIG. 4, there are numerous engraved dots 423 arranged in specific pattern in the light guide plate 421. Every dot 423 served as a microstructure to disturb the TIR (total internal reflection) in light guide plate 421 and allow the light beam to propagate out of the light guide plate 421. In this embodiment, the position aligning to the light source 425 (aligned with vertical dashed line 428) in the light guide plate 421 has least dots distribution, while the position aligning to the midpoint of two light sources 425 (aligned with vertical dashed line 429) has most dots distribution. This is because the position closer or aligned to the light source 425 has higher luminance than other positions, thus the bright stripes are produced, which is so-call the curtain mura as shown in the FIG. 4. Accordingly, lesser dots are engraved in this area to attain the even luminance distribution along X-axis in the light guide plate. The pattern 427 delineates the cross-section view of dots distribution in light guide plate 421 along the X-axis. Similarly, the position aligning to the light source has least dots distribution in pattern 427. Coordinate axis 420 illustrates the distribution of dot density along the Y-axis in the light guide plate 421. As showed in the FIG. 4, most dots in light guide plate 421 are distributed in the location within the distance B along the Y-axis. The distance B in FIG. 4 indicates the area that curtain mura occurs in the light guide plate with V-cut structure. The dots distribution in the embodiment of present invention can raise luminance at the position between LED light sources to cure the curtain mura effect hence improving the luminance uniformity. Note that in FIG. 4, the distance between each light source 425 is not necessarily identical, and the distance between the light guide plate 421 and each light source can be different too. The dots distribution inside the light guide plate 421 depends on the position of light sources thereof in the embodiment of present invention.

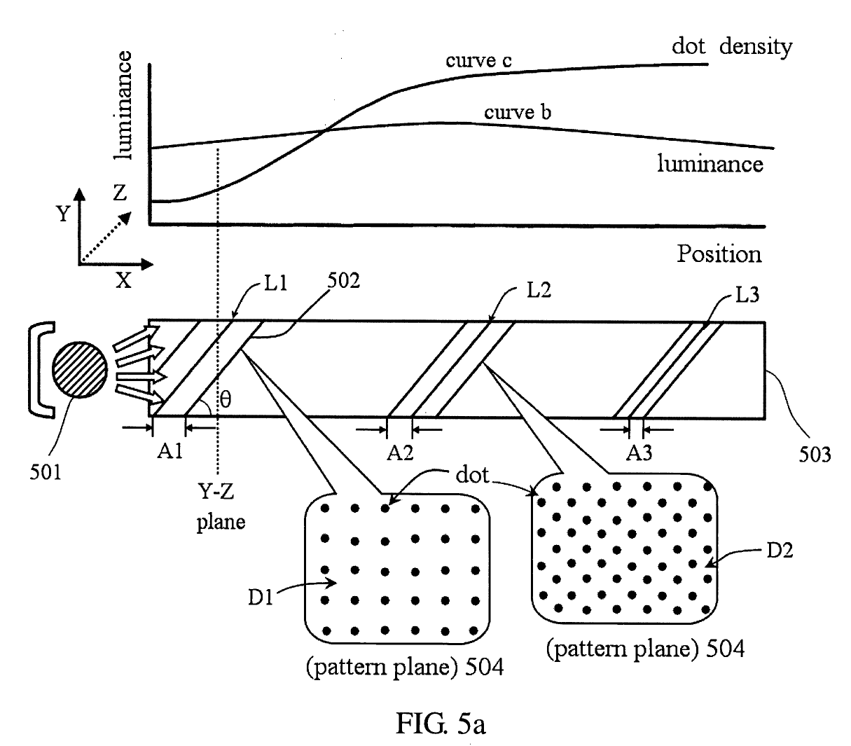

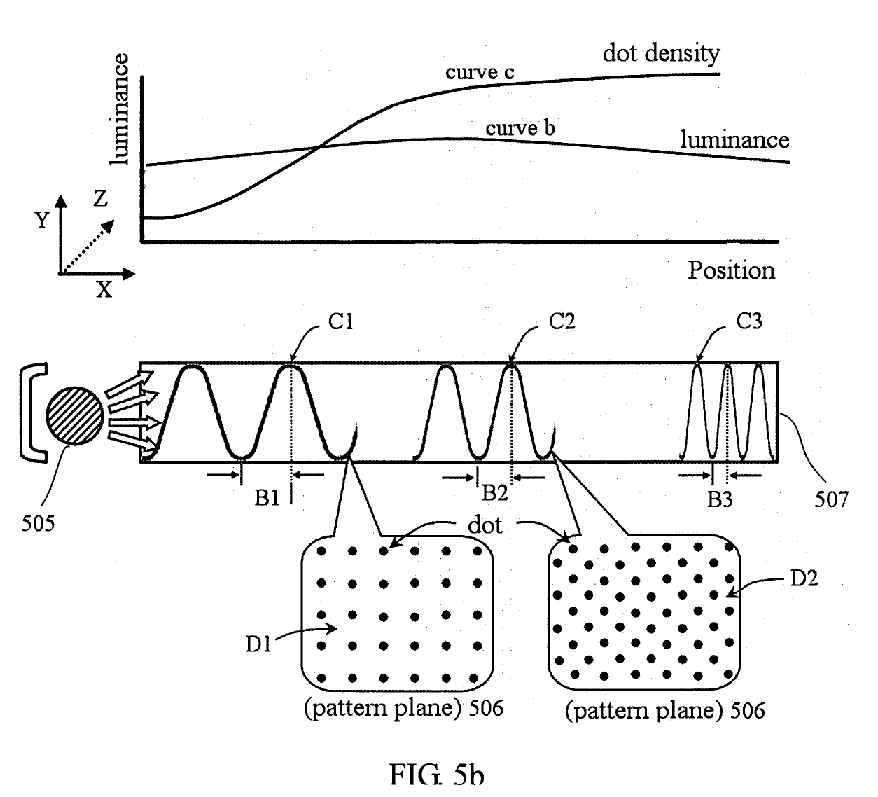

As reminded in FIG. 2a, the light source of edge-light type backlight module is disposed at the lateral of the light guide plate. The present invention discloses a novel method to form the internal refraction pattern in light guide plate by laser engraving. The internal refraction pattern, such as the aggregation of micro dots or cracks, can scatter the incident light passing therethrough in all directions. Referring now to FIG. 5a, which illustrates one kind of laser engraving pattern in the light guide plate used in edge-light type backlight module and the distribution of dot density thereof in the embodiment of present invention. In the figure, a light source 501 is disposed at the lateral side of a light guide plate 503 having a plurality of slant plane 502 provided therein. Every slant planes (L1, L2, L3) in light guide plate 503 is a cross section of pattern plane 504 perpendicular to this page. The slant lines in this embodiment show the cross-sectional pattern of 3D dots distribution and are used to indicate the gradient of dot pattern density. As shown in the FIG. 5a, numerous engraved dots are spread on the pattern plane 504. The pattern density on different position along the X-axis is designated by L1, L2 and L3 (i.e. line density in the aspect of two dimensional cross section view). Additionally, the pitch A1, A2, A3 among each patter plane with different dot density are also defined for later description. The pattern density L1, L2, L3 and pitch A1, A2, A3 can be modulated to form a gradient of pattern density along the X-axis in the process of laser engraving in the embodiment of present invention. The plane pattern density in this position (L1) must lower than the plane pattern density in other position (L2 and L3) to suppress the higher luminance. Similarly, the pitch A1 in this position must be larger than the pitches in other place (A2 and A3) because wider pitch indicates there would be lesser pattern plane intersecting with the Y-Z plane in the figure, thus the total dot number in this position is lesser. When the light guide plate 503 is provided with the internal dot density distribution as the curve “c” in FIG. 5a, the resulted luminance distribution will be like the curve “b” in the figure. Obviously, forming dot density pattern distribution inside the light guide plate 503 can significantly increase the luminance in the position further away from the light source 501. This also improves the entire luminance uniformity of light guide plate 503. Note that the recitation of slant planes L1, L2, L3 and pitches A1, A2, A3 in current embodiment is for the purpose of description, it doesn't indicate that there are a plurality of slant planes and pitch provided substantially inside the light guide plate 503, and each slant planes provided in the light guide plate 503 is not necessarily identical. The concept of pattern plane density and pitch is to demonstrate a method for forming desired gradient of dot density along x-axis in light guide plate by modulating the parameters L1, L2, L3 (line density in light guide plate) and A1, A2, A3 (the pitch between each pattern plane). The number of pitch and pattern density is not limited in the embodiment of present invention. Instead, it may be a successive or non-successive distribution along X-axis in light guide plate 503. Moreover, the tilt angle θ and dot density (D1, D2) of each slant plane in present embodiment can also be modulated to attain desired dots distribution in the light guide plate 503. The distribution of dot on pattern plate 504 is not necessarily uniform. Actually, the random distribution of engraved dot on pattern plane 504 may attain better luminance than uniform distribution. Besides, controlling the dot size can also influence the luminance performance. In summary, to achieve the desired luminance distribution (i.e. the curve c dot density distribution), some parameter, such as line density L1, L2, L3, the tilt angle θ of slant plane, plane pitch A1, A2, A3, dot density D1, D2 and dot size in the embodiment of present invention can be modulated to attain desired dots distribution.

In addition, the laser engraving method in the embodiment of present invention can be coordinated with other conventional diffusion techniques, such as ink printing, diffusion particle and micro structure in prior art, to obtain more excellent luminance uniformity. Moreover, the dot pattern can also form on the top surface and bottom surface of light guide plate or diffusion plate by laser engraving to further improve the luminance uniformity of the light guide plate 505. The laser engraving method in present invention can be utilized in transparent or translucent materials, and the material of diffusion plate can be PC (Polycarbonate), PMMA (polymethylmethacrylate), MS (methylstyrene) and glass, etc.

In one embodiment of present invention, another example of density distribution of dot pattern is provided in a light guide plate used in edge-light type backlight module structure. Referring now to FIG. 5b, in the figure, a light source 505 is disposed at the lateral side of a light guide plate 507 having a plurality of sinusoidal curves provided therein. Every sinusoidal curve (C1, C2, C3) in light guide plate 507 is a cross section of dot pattern plane perpendicular to this page. The sinusoidal curves in this embodiment show the cross-sectional pattern of 3D dots distribution and are used to indicate the gradient of dot pattern density. As shown in the FIG. 5b, numerous engraved dots are spread on the pattern plane 506. The densities of sinusoidal curves along X-axis are designated by C1, C2 and C3 (i.e. curve density in the aspect of two dimensional cross section view). Additionally, the distance on X-axis between wave crest and wave trough is designated by B1, B2, B3 (cycle distance) for further description. Similar to the embodiment in FIG. 5a, a gradient distribution of dot density is necessary to compensate the non-uniform luminance distribution in edge-light type backlight module. The number of dots engraved in light guide plate 507 along the X-axis must increase progressively with the distance from the light source 505, as the dot density distribution of curve c in FIG. 5b. To achieve this object, the curve density C1, C2, C3 and cycle distance B1, B2, B3 can be modulated to form a gradient of pattern density along the X-axis in the process of laser engraving in the embodiment of present invention. Similarly, the cycle distance B1 in this position must be larger than the cycle distance in other place (B2 and B3) because the wider cycle distance indicate that the length of sinusoidal curve distributed in per unit length along the X-axis is shorter, thus the dots distributed in this area is lesser. For example, it is assumed that B1=2*B2=4*B3, then for the same length B1, there will be half of the first sinusoidal wave C1 fall therein, but for sinusoidal wave C2 and C3, there are one sinusoidal wave C2 and two sinusoidal waves C3 fall therein respectively. Shorter length of sinusoidal curve also means that the dots disposed in that position is lesser. Thus modulating the cycle distance B1, B2, B3 along the X-axis can control the distribution of dot density in diffusion plate 507. When the light guide plate 507 is provided with the internal dot density distribution as the curve “c” in FIG. 5c, the resulted luminance distribution will be like the curve “b” in the figure. Obviously, forming dot density pattern distribution inside the light guide plate 507 can significantly increase the luminance in the position further away from the light source 505. This also improves the entire luminance uniformity of light guide plate 507. Note that the recitation of sinusoidal curve C1, C2, C3 and cycle distance B1, B2, B3 in current embodiment is for the purpose of description, it doesn't indicate that there are a plurality of sinusoidal curve and cycle distance provided substantially inside the light guide plate 507. The concept of sinusoidal curve density and cycle distance is to demonstrate a method for forming desired gradient of dot density along x-axis in light guide plate by modulating the parameters C1, C2, C3 (dot density on the curve plane) and B1, B2, B3 (cycle distance of each sinusoidal curve). The number of sinusoidal curve and cycle distance is not limited in the embodiment of present invention. Instead, it may be a successive or non-successive distribution along X-axis in light diffusion plate 507. Moreover, the dot density (D1, D2) of each pattern plane 506 in present embodiment can also be modulated to attain desired dots distribution in the light guide plate 505. The distribution of engraved dot on pattern plate 506 is not necessarily uniform. Actually, the random distribution of engraved dot on pattern plane 506 can attain better luminance than uniform distribution. Besides, controlling the dot size can also influence the luminance performance. In summary, to achieve the desired luminance distribution (i.e. the curve c dot density distribution in FIG. 5b), some parameter, such as curve density C1, C2, C3, cycle distance B1, B2, B3, dot density D1, D2, D3 and dot size in the embodiment of present invention can be modulated to attain desired dots distribution.

In addition, the laser engraving method in the embodiment of present invention can be coordinated with other conventional diffusion techniques, such as ink printing, diffusion particle and micro structure in prior art, to obtain more excellent luminance uniformity. Moreover, the dot pattern can also form on the top surface and bottom surface of light guide plate or diffusion plate by laser engraving to further improve the luminance uniformity of the light guide plate 507. The laser engraving method in present invention can be utilized in transparent or translucent materials, and the material of diffusion plate can be PC (Polycarbonate), PMMA (polymethylmethacrylate), MS (methylstyrene) and glass, etc.

While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalents are intended to be embraced therein.

What is claimed is:

1. A diffusion plate, comprising:
a substrate;
a plurality of light scattering dots formed within said substrate by laser engraving, wherein the density distribution of said light scattering dots within said substrate is in Gauss distribution whose maximum is aligning to the position of a plurality of light source and whose minimum is aligning to the midpoint between said a plurality of light source.

2. The diffusion plate of claim 1, wherein said a plurality of light source includes but not limited to CCFL lamp or LED light source disposed in any arrangement under said diffusion plate.

3. The diffusion plate of claim 1, wherein said scattering dots can also be formed on the top surface, bottom surface of said substrate by laser engraving.

4. The diffusion plate of claim 1, wherein said diffusion plate can coordinate with other diffusion techniques including ink printing, diffusion pattern and micro structure to obtain better luminance uniformity.

5. The diffusion plate of claim 1, wherein the material of said substrate includes PC (Polycarbonate), PMMA (polymethylmethacrylate), MS (methylstyrene), quartz and glass.

6. The diffusion plate of claim 1, wherein said diffusion plate is transparent or translucent.

7. A light guide plate, comprising:
a substrate;
a plurality of light scattering dots formed within said substrate by laser engraving, wherein said internal scattering dots are arranged on a plurality of slant planes space-parted from each other; the density of said slant planes in said substrate, the dot density on said slant planes, the tilt angle of said slant planes, the dot size and the pitch between said slant planes are all variable and controllable by laser engraving.

8. The light guide plate of claim 7, wherein said light scattering dots can also be formed on the top surface, bottom surface of said substrate by laser engraving.

9. The light guide plate of claim 7, wherein said light guide plate can coordinate with other diffusion techniques including ink printing, diffusion pattern and micro structure to obtain better luminance uniformity.

10. A light guide plate, comprising:
a substrate;
a plurality of light scattering dots formed within said substrate by laser engraving, wherein said light scattering dots are arranged on a plurality of sinusoidal curve planes which propagate along said substrate; the density of said sinusoidal curve planes, the dot density on said sinusoidal curve planes, the dot size and the cycle distance of said sinusoidal curve planes are all variable and controllable by laser engraving.

11. The light guide plate of claim 10, wherein said light scattering dots can also be formed on the top surface, bottom surface of said substrate by laser engraving.

12. The light guide plate of claim 10, wherein said light guide plate can coordinate with other diffusion techniques including ink printing, diffusion pattern and micro structure to obtain better luminance uniformity.

13. A light guide plate to resolve the curtain mura issue, comprising:
a substrate;
a plurality of light scattering dots formed within said substrate by laser engraving, wherein said light scattering dots are disposed within said substrate in the side closer to the light source, the dot density decreases as the distance from said light source increases, and the minimum distribution of said light scattering dots is aligned to the position of light source, the maximum distribution of said light scattering dots is aligned to the position of midpoint between said light sources.

14. The light guide plate of claim 13, wherein said light guide plate can coordinate with other diffusion techniques including ink printing, diffusion pattern and micro structure to obtain better luminance uniformity.

15. A light guide plate to resolve the kido mura issue, comprising:
a substrate;
a plurality of V-cut microstructure formed on the bottom surface of said substrate;
a plurality of light scattering dots formed within said substrate by laser engraving, wherein said light scattering dots are disposed within said substrate in the side closer to the light source.

16. The light guide plate of claim 15, wherein said light guide plate can coordinate with other diffusion techniques including ink printing, diffusion pattern and micro structure to obtain better luminance uniformity.

17. A method of forming internal scattering dots by laser engraving, comprising the step of:
providing a substrate; and
forming internal scattering dots within said substrate by laser engraving, wherein the density distribution of said internal scattering dots within said substrate is in Gauss distribution whose maximum is aligning to the position of a plurality of light source and whose minimum is aligning to the midpoint between said plurality of light source.

18. The method of claim 17, wherein said internal scattering dots can also be formed on the top surface, bottom surface of said substrate by laser engraving.

19. The method of claim 17, wherein said laser engraving method can coordinate with other diffusion techniques including ink printing, diffusion pattern and micro structure to obtain better luminance uniformity.

20. The method of claim 17, wherein said a plurality of light source can be CCFL lamp or LED light source disposed in any arrangement under said diffusion plate.

21. A method of forming internal scattering dots by laser engraving, comprising the step of:
providing a substrate;
forming internal scattering dots within said substrate by laser engraving, wherein said internal scattering dots are arranged on a plurality of slant plane space-parted from each other; the density of said slant planes in said substrate, the dot density on said slant planes, the tilt angle of said slant plane, the dot size and the pitch between said slant planes are all variable and controllable by laser engraving.

22. The method of claim 21, wherein said internal scattering dots can also be formed on the top surface, bottom surface of said substrate by laser engraving.

23. The method of claim 21, wherein said laser engraving method can coordinate with other diffusion techniques including ink printing, diffusion pattern and micro structure to obtain better luminance uniformity.

24. The method of claim 21, wherein said a plurality of light source includes but not limited to CCFL lamp or LED light source disposed in any arrangement at the lateral side of said substrate.

25. A method of forming internal scattering dots by laser engraving, comprising the step of:
providing a substrate;
forming internal scattering dots within said plate by laser engraving, wherein said internal scattering dots are arranged on a plurality of sinusoidal curve plane which propagate along said substrate; the density of said sinusoidal curve plane, the dot density on said sinusoidal curve plane, the dot size and the cycle distance of said a plurality of sinusoidal curve plane are all variable and controllable by laser engraving.

26. The method of claim 25, wherein said internal scattering dots can also be formed on the top surface, bottom surface of said substrate by laser engraving.

27. The method of claim 25, wherein said laser engraving method can coordinate with other diffusion techniques including ink printing, diffusion pattern and micro structure to obtain better luminance uniformity.

28. The method of claim 25, wherein said a plurality of light source can be CCFL lamp or LED light source disposed in any arrangement at the lateral side of said substrate.

29. A method of forming internal scattering dots by laser engraving to resolve curtain mura issue, comprising the step of:
providing a substrate;
forming internal scattering dots within said plate by laser engraving, wherein said light scattering dots are disposed within said substrate in the side closer to the light sources, the dot density decreases as the distance from said light source increases, and the minimum distribution of said light scattering dots is aligned to the position of light source, the maximum distribution of said light scattering dots is aligned to the position of midpoint between said light sources.

30. The method of claim 29, wherein said laser engraving method can coordinate with other diffusion techniques including ink printing, diffusion pattern and micro structure to obtain better luminance uniformity.

31. A method of forming internal scattering dots by laser engraving to resolve kido mura issue, comprising the step of:
providing a substrate with V-cut microstructure formed on the bottom surface thereof;
forming internal scattering dots within said substrate by laser engraving, wherein said light scattering dots are disposed within said substrate in the side closer to the light source.

32. The method of claim 31, wherein said laser engraving method can coordinate with other diffusion techniques including ink printing, diffusion pattern and micro structure to obtain better luminance uniformity.
